(19) United States
(12) Patent Application Publication
(10) Pub. No.: US 2025/0373285 A1
(43) Pub. Date: Dec. 4, 2025

(54) METHOD FOR COOPERATIVE RETRANSMISSION IN AN OMAMRC SYSTEM

(71) Applicant: Orange, Issy-Les-Moulineaux (FR)

(72) Inventors: Raphaël VISOZ, Chatillon Cedex (FR); Ali AL KHANSA, Chatillon Cedex (FR)

(21) Appl. No.: 18/875,063

(22) PCT Filed: Jun. 14, 2023
(86) PCT No.: PCT/EP2023/066008

§ 371 Date: Dec. 13, 2024

(30) Foreign Application Priority Data
Jun. 16, 2022 (FR) FR2205907

(51) Int. Cl. H04B 7/026; H04B 7/024; H04B 7/0456; H04L 1/1809

(52) U.S. Cl. CPC H04B 7/026; H04B 7/024; H04B 7/0456; H04L 1/1809

(57) ABSTRACT

A transmission method intended for an OMAMRC telecommunication system with M sources (s₁, . . . , s_{M}), possibly L relays and one destination, M≥2, L≥0. In such a solution, when a source could not be decoded by the destination, the latter organises a retransmission by taking into account the characteristics of a MIMO transmission channel established between, on the one hand, at least two nodes that decoded the source and, on the other hand, at least two antennas in reception of the destination in the form of a precoding coefficient. Thus, the method therefore makes it possible to improve the decoding performance of a source sᵢ, in a context where the destination is equipped with a plurality of antennas in reception.

### CROSS-REFERENCE TO RELATED APPLICATIONS

This application is filed under 35 U.S.C. § 371 as the U.S. National Phase of Application No. PCT/EP2023/066008 entitled “METHOD FOR COOPERATIVE RETRANSMISSION IN AN OMAMRC SYSTEM” and filed Jun. 14, 2023, and which claims priority to FR 2205907 filed Jun. 16, 2022, each of which is incorporated by reference in its entirety.

### BACKGROUND

### Field

The present development relates to the field of digital communications. Within this field, the development relates more particularly to the transmission of coded data between at least two sources and one destination with relaying by nodes which can be relays or sources.

It is understood that a relay has no message to transmit. A relay is a node dedicated to relaying messages from the sources, whereas a source has its own message to transmit, and is further operable in some cases to relay the messages from the other sources, i.e. the source is referred to as cooperative in that case.

There are many different relaying techniques: “amplify and forward”, “decode and forward”, “compress-and-forward”, “non-orthogonal amplify and forward”, “dynamic decode and forward”, etc.

The development applies in particular, but not exclusively, to data transmission via mobile networks, for example for real-time applications, or via, for example, sensor networks.

Such a sensor network is a multi-user network, made up of several sources, several relays and one destination that can use an orthogonal multiple-access scheme of the transmission channel between the sources and the destination, known as OMAMRC (“Orthogonal Multiple-Access Multiple-Relay Channel”).

According to this scheme, orthogonality between the transmissions of the sources and the relays is achieved by a time multiplexing in the form of discontinued time slots.

### Description of the Related Technology

An OMAMRC transmission system implementing a slow channel adaptation is known from application WO 2019/162592 published on Aug. 29, 2019.

An OMAMRC telecommunications system has M sources, possibly L relays and one destination, M≥2, L≥0 with an implementation of a time orthogonal multiple-access scheme of the transmission channel that applies between the nodes taken among the M sources and the L relays. The maximum number of time slots per transmitted frame is M+Tₘₐₓ with M time slots allocated during an initial phase to the successive transmission of the M sources and T_{used}≤Tₘₐₓ time slots for more cooperative transmissions allocated during a second phase to one or more nodes selected by the destination according to a selection strategy.

The known OMAMRC transmission system comprises at least two sources, each of these sources being able to function at different times either exclusively as a source, or as a relaying node. The system may further include relays. The node terminology covers both a relay and a source acting as a relaying node or as a source. The system under consideration is such that the sources can themselves be relays. A relay differs from a source in that it has no message of its own to transmit, i.e. it simply retransmits messages from other nodes.

The channels between the different nodes of the system are subject to slow fading and white Gaussian noise. The knowledge of all the system's channels (CSI: Channel State Information) by the destination is not available. Indeed, the channels between the sources, between the relays, between the relays and the sources are not directly observable by the destination, and their knowledge by the destination would require an excessive exchange of information between the sources, the relays and the destination. To limit the cost of feedback overhead, only one item of information about channel distribution/statistical distribution (CDI: Channel Distribution Information) of all channels, e.g. the average quality (for example average SNR, average SINR) of all channels, is assumed to be known by the destination in order to determine the rates allocated to the sources.

Channel adaptation is referred to as of the slow type, i.e. before any transmission, the destination allocates initial rates to the sources knowing the distribution of all channels (CDI: Channel Distribution Information). In general, CDI distribution can be traced back based on the knowledge of the average SNR or SINR of each channel of the system.

During the transmissions of frame-formatted messages of the sources, the CSI of the channels is assumed to be constant (slow fading assumption). Bitrate allocation is assumed not to change for several hundred frames, but to change only according to CDI changes.

A method for transmission implemented in such an OMAMRC system comprises three phases, an initial phase and, for each frame to be transmitted, a 1^{st} phase and a 2^{nd} phase. The transmission of a frame occurs in two phases, which may be preceded by an additional phase referred to as initial.

During the initialisation phase, the destination determines an initial bitrate for each source, taking into account the average quality (for example SNR) of each channel of the system.

The destination estimates the quality (for example SNR) of the direct channels: source to destination and relay to destination according to known techniques based on the use of reference signals. The quality of the source-to-source, relay-to-relay and source-to-relay channels is estimated by the sources and the relays by using, for example, the reference signals. The sources and the relays transmit the average qualities of the channels to the destination. This transmission takes place before the initialisation phase. As only the average value of the quality of a channel is taken into account, it is refreshed on a long time scale, i.e. over a time that allows the fast fading of the channel to be averaged out. This time is of the order of the time required to cover several tens of wavelengths of the frequency of the transmitted signal for a given speed. The initialisation phase occurs, for example, every 200 to 1,000 frames. The destination sends the initial rates it has determined back to the sources via a return path. The initial rates remain constant between two occurrences of the initialisation phase.

During the first phase, the M sources successively transmit their message during the M time slots, using respectively modulation and coding schemes determined from the initial rates. During this phase, the number N₁ of channel uses (i.e. resource elements according to 3GPP terminology) is fixed and identical for each of the sources.

During the second phase, the messages from the sources are transmitted co-operatively by the relays and/or the sources. This phase lasts for a maximum of Tₘₐₓ time slots. During this phase, the number N₂ of channel uses is fixed and identical for each of the selected nodes (source and relay).

During the first phase, the independent sources broadcast their messages in the form of coded information sequences to a single destination. Each source broadcasts its messages at the initial bitrate. The destination communicates its initial bitrate to each source via very limited feedback control channels. Thus, during the first phase, each source in turn transmits its respective message, during the time slots each dedicated to one source.

The sources other than the transmitting source, and possibly the relays, of the “Half-Duplex” type receive the successive messages from the sources, decode them and, if they are selected, generate a message only from the messages from the sources decoded without error.

The selected nodes then access the channel orthogonally in time with one another during the second phase to transmit their generated message to the destination.

The destination can choose which node to transmit at a given time.

Although such a solution makes it possible to maximise the average spectral efficiency (utility metric) within the system under consideration, provided that an individual quality of service (QOS) per source is respected, it is desirable to try to improve the decoding performance of a given source further, more particularly when the destination comprises a plurality of antennas in reception.

The present development meets this objective.

### SUMMARY

To this end, the purpose of the present development is a transmission method for an OMAMRC telecommunication system with N nodes and a destination (d) comprising at least two antennas in reception, the N nodes comprising M sources (s₁, . . . , s_{M}), possibly L relays (r₁, . . . , r_{L}) with M≥2, L≥0.

Such a method is particular in that it comprises a first phase during which the destination receives first redundancies (RV0) of messages transmitted successively by the M sources, the message of a source having been coded before transmission by a coding of the incremental redundancy type comprising several redundancies and a second phase comprising the following steps implemented by the destination (d):
broadcasting a control message identifying one or more sources for which it has not decoded said transmitted message without error, referred to as undecoded sources,
receiving at least one identifier from at least one source sᵢ undecoded by the destination transmitted by a first set of nodes comprising at least one first node and one second node, taken from among the N nodes, having decoded without error said message from a source sᵢ,
determining a first coefficient and a second coefficient representative of a multiple-input multiple-output transmission channel established between said at least two nodes and at least two antennas in reception of the destination, said first and second precoding coefficients of the first node and the second node respectively,
transmitting a retransmission request of said message from the source sᵢ to said at least two nodes, said retransmission request comprising said first precoding coefficient and said second precoding coefficient,
receiving a second redundancy of the message from said source s; transmitted by said first and second nodes, said first node applying to said retransmission the first precoding coefficient received and said second node applying to said retransmission the second precoding coefficient received.

Taking into account the characteristics of a composite transmission channel of the SIMO type (Single Input-Multiple Output) established between said node and the destination consisting of at least two SISO (Single Input-Single Output) transmission channels established respectively between said node and a first antenna of said destination and between said node and a second antenna of the destination in the form of a precoding coefficient, the development improves the known methods. The present solution makes it possible to improve the decoding performance of a source sᵢ, in a context where the destination is equipped with a plurality of antennas in reception, by performing a coherent addition of the SISO transmission channels established between a node which has decoded without error the message transmitted by the source s; and a reception antenna of the destination, which makes it possible to maximise the signal-to-noise ratio of the composite SIMO transmission channel established between the said node and the destination consisting of at least two SISO transmission channels.

Thus, the node applies the received precoding coefficient to the radio signal carrying a second redundancy of the message from the source. The first and second redundancies may be identical, for example when a repeating code is used, or may not and may or may not include systematic bits.

In the present development, it is specified that the first redundancy is a codeword. The fact that the first redundancy is a codeword makes it possible to trace back to the transmitted message because there is a unique correspondence between the codeword and the message, which requires a coding efficiency of less than or equal to 1.

In a first example of the method covered by the development, the method also comprises a step of selecting said source sᵢ from a set of sources undecoded by the destination whose identifiers are received from the nodes, taken among the N nodes having decoded without error at least one message from said sources not decoded by the destination.

Indeed, depending on the circumstances, several messages transmitted by different sources may not have been decoded without error by the destination. Rather than leaving the choice of the message to be encoded and transmitted by a node selected by the destination on the basis of the messages decoded by this node and not decoded by the destination, as it is the case in the state of the art, the destination imposes, in the present solution, the choice of the message and therefore of the source for which a retransmission is required by one or more nodes. Thus, all the nodes involved in this retransmission can collaborate by retransmitting the same redundancy of the same message without this retransmission being interfered with by the retransmission of another message by other nodes.

In another example of the method covered by the development, the precoding coefficient is a coefficient of an eigenvector vᵢ of

$${H}_{i}^{†} {R}_{i}^{- 1} {H}_{i}$$

where

$${H}_{i}^{†}$$

is the conjugate or the transpose of a matrix Hᵢ representing a global transmission channel consisting of all the composite transmission channels established between each of the nodes having decoded without error said message transmitted by said source s; and the destination, and Rᵢ⁻¹ is the inverse matrix of a covariance matrix Rᵢ of the global transmission channel.

Such a transmission mode, referred to as Maximal Ratio Transmission or MRT makes it possible to obtain, on the destination side, a coherent combination of all the signals transmitted by at least one node that decoded without error said message transmitted by said source sᵢ selected and received by its different antennas in reception.

In another example of the method covered by the development, the source sᵢ selected is the source for which a signal-to-noise ratio associated with said global transmission channel is the highest.

By choosing the source for which the composite transmission channel has a high signal-to-noise ratio, the destination increases its chances of decoding without error the retransmitted message.

In another example of the method covered by the development, said request for retransmission of said at least one message transmitted by the source sᵢ comprises said eigenvector vᵢ.

In this example, the nodes that decoded without error the message transmitted by the source sᵢ receive the eigenvector vᵢ and identify the coefficient of the vector associated with them in anticipation of the retransmission of the second redundancy.

The request for retransmission of said at least one message transmitted by the source sᵢ also includes a vector nᵢ representative of the cardinality of the set of nodes comprising at least one node that decoded without error said message transmitted by the source sᵢ, a coefficient of said vector nᵢ making it possible for at least one node of said set to identify the coefficient of the eigenvector vᵢ to be applied during the retransmission of the second redundancy.

In another implementation of the present solution, the messages intended to be transmitted by the M sources (s₁, . . . , s_{M}) are encoded using an incremental redundancy code and segmented into a plurality of redundancy blocks.

The development also relates to a system comprising M sources (s₁, . . . , s_{M}), L relays (r₁, . . . , r_{L}) and one destination (d), M≥2, L≥0, for implementing a transmission method according to one of the preceding purposes.

The purpose of the development is also a computer program product comprising program code instructions for implementing a method according to the development, as described previously, when it is executed by a processor.

The purpose of the development is also a computer-readable storage medium on which is saved a computer program comprising program code instructions for implementing the steps of a method according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the method covered by the above-mentioned development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1: this figure shows an embodiment of the development described in the context of an OMAMRC system,

FIG. 2: this figure shows a transmission cycle of a frame,

FIG. 3: this figure shows the various stages of the transmission method covered by the development implemented by the system of FIG. 1,

FIG. 4: this figure shows a circular buffer used to select a redundancy of the message to be transmitted,

FIG. 5: this figure shows a destination belonging to an OMAMRC telecommunication system with M sources, optionally L relays and a destination, M≥2, L≥0 according to an embodiment of the development.

### DETAILED DESCRIPTION OF CERTAIN ILLUSTRATIVE EMBODIMENTS

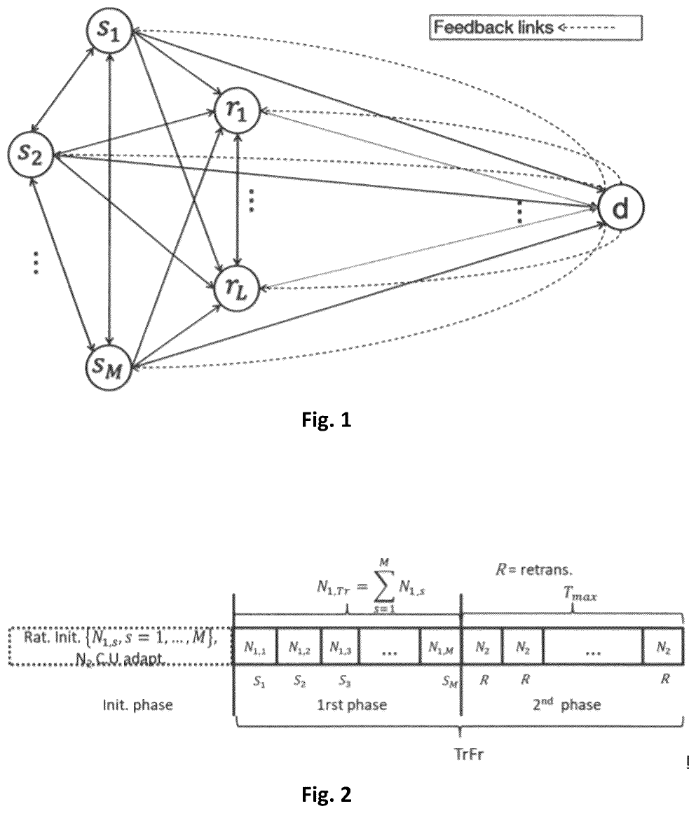

In relation to FIG. 1, an embodiment of the development described in the context of an OMAMRC system in support of the diagram in FIG. 2 which illustrates a transmission cycle of a frame is now presented.

This system includes M sources belonging to the set of sources [symbol] ={s₁, . . . , s_{M}}, L relays belonging to the set of relays [symbol] ={r₁, . . . , r_{L}} and one destination d. By convention, it is assumed that sᵢ=i∀i∈{1, . . . , M} and rᵢ=M+i∀i∈{1, . . . , L}.

Every source in the set [symbol] communicates with the single destination with the help of the other sources (user cooperation) and the relays that cooperate.

Nodes include the M relays and the Lsources which can behave like a relay when they are not transmitting their own message.

As a simplification of the description, the following assumptions are then made about the OMAMRC system:
the sources and the relays are equipped with a single transmission antenna;
the sources and the relays are equipped with a single reception antenna;
the destination is equipped with N_{R}>1 reception antennas;
the sources, the relays and the destination are perfectly synchronised;
the sources are statistically independent (there is no correlation between them);
all nodes transmit with the same power;
a CRC code assumed to be included in the Kₛ information bits corresponding to the message of each sources determine whether or not this message was correctly decoded;
the channels between the different nodes suffer from additive noise and fading. The fading gains are fixed during the transmission of a frame for a maximum duration of M+Tₘₐₓ time slots, but may change independently from frame to frame. Tₘₐₓ≥1 is a system parameter;
the instantaneous quality of the direct channel in reception (CSIR Channel State Information at Receiver) is available at the destination, sources and relays;
the returns are error-free (no errors on the control signals).

The nodes, M sources and L relays access the transmission channel according to a multiple access scheme orthogonal in time which enables them to listen to the transmissions of the other nodes without interference. The nodes operate in a “half-duplex” mode.

The following notations are used:
Gᵢ is the set of nodes n_{i,j} that decoded without error the message uᵢ transmitted by the source sᵢ during a time slot where j∈{1, . . . , |Gᵢ|} and |Gᵢ| is the cardinality of the set Gᵢ,
vᵢ∈ [symbol] ^{|G}^{ᵢ}^{|} is the precoding vector to be applied to the nodes of |Gᵢ|, the coefficient v_{i,j} being to be applied to a node n_{i,j},
x_{a,k} is the modulated symbol coded for use of the channel k transmitted by the node a∈ [symbol] ∪U [symbol] , where k∈{1, . . . , N_{1,s}} during a transmission phase and k∈{1, . . . , N₂} during a retransmission phase,
r is the reception antenna index for any node, for a source node or relay node r=1 for the destination r∈{1, . . . , N_{R}} with N_{R} the number of reception antennas
y_{a,b,k,r} is the signal received by the antenna r of the node b∈S∪R∪{d}\{a} for the use of channel k corresponding to a signal transmitted by the node a∈ [symbol] ∪ [symbol] ,
yₛ_{ᵢ}_{, b,k,r} is the signal received by the antenna r of the node b∈S∪R∪{d}\Gᵢ for the use of channel k corresponding to the signals transmitted by the nodes ∀j∈{1, . . . , |Gᵢ|}n_{i,j}∈Gᵢ,
γ_{a,b} is the average signal-to-noise ratio (SNR) per reception antenna which takes into account the effects of path loss and shadowing,
h_{a,b,r} is the channel fading gain for the antenna r of the node a to the node b which follows a symmetrical circular complex Gaussian distribution with zero mean and variance γ_{a,b} (the received power is proportional to the transmitted power), the gains are independent of each other,
n_{a,b,k,r} or nₛ_{ᵢ}_{,b,k,r} are samples of a white Gaussian noise (AWGN) distributed in an identical and independent manner that follow a complex Gaussian distribution of circular symmetry with zero mean and unitary variance.

Rₛ is a variable representing the initial bitrate of the source s which can take its values in the finite set {R̅₁, . . . ,

$${\overline{R}}_{{n}_{M C S}} \}$$

Similarly, αₛ is a variable representing the ratio N₂/N_{1,s} which can take its values in a finite set A={α̅₁, . . . , ā_{|A|}}.

The signal received by the antenna r of the node b∈ [symbol] ∪ [symbol] ∪{d}\{a} for the use of channel k corresponding to the signal transmitted by the node a∈ [symbol] during the first phase can be noted:

$${y}_{a , b , k , r} = {h}_{a , b , r} {x}_{a , k} + {n}_{a , b , k , r} \qquad ( 1 )$$

The signal received by the antenna r of the node b∈ [symbol] ∪ [symbol] ∪{d}\Gᵢ for the use of channel k corresponding to the signals transmitted by the nodes belonging to the set Gᵢ during the second phase can be written as:

$${y}_{{s}_{i} , b , k , r} = ( {\sum }_{j = 1}^{\vert {G}_{i} \vert} {h}_{{n}_{i , j} , b , r} {v}_{i , j} ) {x}_{k} + {n}_{{s}_{i} , b , k , r} \qquad ( 2 )$$

where xₙ_{_{i,j}}_{,k}=v_{i,j}xₖ∀j∈{1, . . . , |Gᵢ|}n_{i,j}∈Gᵢ. In fact, the same redundancy version is transmitted by the nodes belonging to Gᵢ so the same symbol xx for the use of channel k. Each node ∀j∈{1, . . . , |Gᵢ|}n_{i,j}∈Gᵢ applies the pre-encoding coefficient V_{i,j} so that the transmitted symbol is xₙ_{_{i,j}}_{,k}=v_{i,j}xₖ∀j∈{1, . . . , |Gᵢ|}n_{i,j}∈Gᵢ. By thus defining a channel with multiple inputs and outputs Hᵢ∈ [symbol] ^{N}^{_{R}}^{×|G}^{ᵢ}^{|} linking the nodes Gᵢ to the destination such that |Hᵢ|_{r,j}=hₙ_{_{i,j}}_{,d,r}, the vector y_{i,k} such that y_{i,k,r}=yₛ_{ᵢ}_{d,k,r} and the vector w_{i,k} such that w_{i,k,r}=nₛ_{ᵢ}_{,d,k,r}, then

$${y}_{i , k} = {H}_{i} {v}_{i} {x}_{k} + {w}_{i , k} .$$

The index k is omitted to simplify the notations hereafter, the model in reception during a retransmission phase where the active nodes are defined by the set Gᵢ for a precoding vector vᵢ then becomes

$${y}_{i} = {H}_{i} {v}_{i} {x}_{{S}_{i}} + {w}_{i}$$

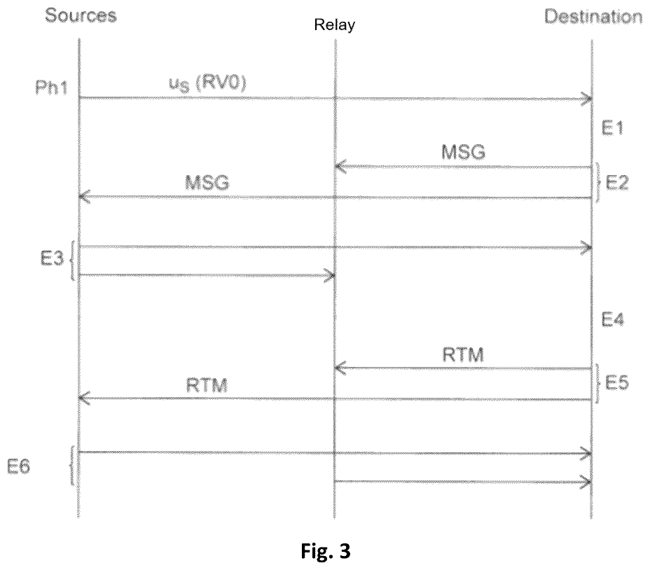

with xₛ_{ᵢ} a symbol of the redundancy version sent by the source Sᵢ. [FIG. 3] shows the various stages of the transmission method covered by the development implemented by the system described above.

During an initial phase Ph1 of M time slots, each source s∈ [symbol] transmits a coded message using a code enabling retransmissions of the incremental redundancy type which transforms the message of length L_{M} into a coded sequence of length L_{c}=L_{M}/R₀>L_{M}. The coded sequence includes a first redundancy RV0 which is a codeword transmitted during N_{1,s} uses of the channel, k∈{1, . . . , N_{1,s}} the number N_{1,s} of uses of the channel and the duration of these uses being dependent on the source s.

By using reference signals (pilot symbols, SRS signals from 3GPP LTE, etc.), the destination can determine the gains (CSI Channel State Information) of the direct channels: h_{dir}={hₛ_{₁}_{,d,r}, . . . , hₛ_{_{M}}_{,d,r}}r=1, . . . , N_{R}, i.e. source-to-destination and relay-to-destination channels, and can therefore deduce the average SNRs of these channels.

However, the gains of channels between sources, channels between relays and channels between sources and relays are not known to the destination. Only sources and relays can estimate a metric for these channels by using reference signals in a similar way to that used for direct channels. Given that the statistics of the channels are assumed to be constant between two initialisation phases, the transmission of metrics to the destination by the sources and relays may only occur at the same bitrate as the initialisation phase. The channel statistic for each channel is assumed to follow a centred circular complex Gaussian distribution and the statistics are independent between channels. It is therefore sufficient to consider only the average SNR as a measure of the statistic of a channel.

The sources and the relays therefore forward to the destination metrics representative of the average SNRs of the channels they can observe.

The destination thus knows the average SNR of each of the channels linking a node to each of the N_{R} reception r antennas of the destination.

During an initial phase of channel adaptation (shown in FIG. 2) which precedes the transmission of several frames, the destination transmits for each source s a value representative (index, MCS, bitrate, etc.) of an initial bitrate R̅ᵢ and a value α̅ᵢ.

Each of the initial bitrates unambiguously determines an initial modulation and coding scheme (MCS) or, vice versa, each initial MCS determines an initial bitrate.

The forwarding of initial bitrates R̅ᵢ and reports α̅ᵢ is transmitted via strictly limited feedback control channels.

Each source transmits its framed messages to the destination using the other sources and the relays.

A frame occupies time slots when transmitting the M messages of the respectively M sources. The transmission of a frame (which defines a transmission cycle) takes place over M+T_{used} time slots: M slots for the first phase with respective capacities, N_{1,i} channel uses for each source i, T_{used} slots for a second phase which will be described later in this document.

During the first phase, each source s∈ [symbol] transmits a coded message uₛ of Kₛ information bits uₛ∈

$${2}_{{K}_{s}}^{} ,$$

[symbol]

₂ being the two-element Galois field. The message uₛ includes a code of the CRC type which is used to check the integrity of the message uₛ. The message uₛ is coded according to the initial MCS. Given that the initial MCSs may differ between sources, the lengths of the coded messages may differ between sources.

The coding applied uses an incremental redundancy code which can be based, for example but not exclusively, on existing codes such as convolutional codes, turbo codes, LDPC, etc.

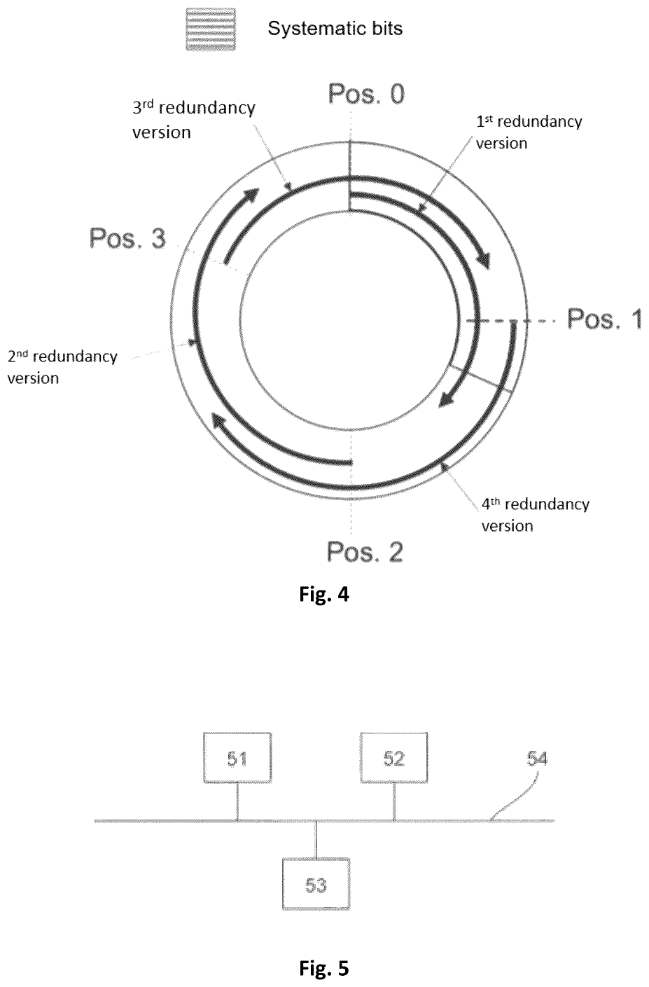

The principle of this type of code is as follows: a message transmitted by each source is encoded into a coded sequence of bits (the message may be segmented into several independently encoded sub-blocks if the message is too long) by a very low-efficiency mothercode (1/3 for example). The coded bits are then placed in a circular buffer shown in FIG. 4 having several reading start positions Pos. 0, Pos. 1, Pos. 2 and Pos. 3. Such a circular buffer contains the coded bits of a message from a source coded by a low-efficiency mothercode and making it possible to select a particular redundancy of the message to be transmitted according to a reading start position in the circular buffer.

These reading start indexes Pos. 0, Pos. 1, Pos. 2 and Pos. 3 correspond to different redundancy blocks/versions, in the example chosen there are four possible redundancy versions. For each redundancy block/version, a node will read the number of coded bits to be sent, corresponding to the number of channel uses available for a given modulation and message size, from the corresponding redundancy position by moving in the circular buffer in the direction of the initial fill. Whether or not the incremental redundancy code is of the systematic type, it is such that the first version of the redundancy block/version can be decoded independently of the other blocks/versions.

Thus, in the first phase, the M sources successively transmit the first redundancy RV0 of their respective messages uₛcoded during the M slots with respectively modulation and coding schemes determined from the initial bitrate values.

Each transmitted message uₛ corresponds to a sources ∈ [symbol] , a correctly decoded message is assimilated to the corresponding source by abuse of notation.

When a source is transmitting, the other sources and relays listen and try to decode the messages received at the end of each time slot.

In a second phase comprising steps E1 to E6, the destination determines in a step E1 whether or not the received messages have been successfully decoded using the CRC.

In the second phase, the selected node, source or relay, acts as a relay by cooperating with the sources to help the destination correctly decode the messages from all the sources. The selected node transmits a redundancy version of a message from a source that it has correctly decoded. The second phase comprises a maximum of Tₘₐₓ time slots called rounds. Each round t∈{1, . . . , T_{used}} has a capacity of N₂ channel uses.

If all the sources are decoded correctly, the destination broadcasts a message of the ACK type. In this case, a transmission cycle of a new frame begins with the clearing of the memories of the relays and destination and with the transmission by the sources of new messages.

If the decoding of at least one source is incorrect, in a step E2, the destination broadcasts one message MSG identifying the source for which it has not decoded without error the transmitted message. Such a source is referred to as an undecoded source.

Such a message broadcast by the destination includes, in a first implementation, identifiers of the sources for which the destination has decoded without error the transmitted message. In this first implementation, the nodes intercepting the broadcast messages determine the sources for which the destination has not decoded without error the transmitted message.

In a second implementation, the message broadcast by the destination includes identifiers of the sources for which the destination has not decoded without error the transmitted message. In this second implementation, the nodes intercepting the broadcast messages immediately know the identity of the sources for which the destination has not decoded without error the transmitted message.

In a third implementation, the message broadcast by the destination includes a message of the NACK type indicating that the destination was unable to decode without error the message sent by at least one source.

The destination informs the nodes using a limited feedback control channel to transmit the messages MSG. These messages MSG are based on the decoding result of the messages received by the destination. The destination thus controls the transmission of the nodes using these messages MSG, which improves spectral efficiency and reliability by increasing the probability of all sources being decoded by the destination.

Upon receiving of a message MSG, each node n_{i,j}∈ [symbol] ∪ [symbol] transmits to the destination, in a step E3, at least one identifier of at least one source for which it has correctly decoded the message uₛ transmitted at the end of the preceding time slot (round) noted Sₙ_{_{i,j}}_{,t-1} and such that this message was not decoded correctly by the destination at the end of the previous round.

By convention, [symbol] _{b,t}⊆ [symbol] is the set of messages (or sources) correctly decoded by the node b∈ [symbol] ∪ [symbol] ∪{d} at the end of the time slot t (round t), t∈{0, . . . , T_{used}−1}. The end of the time slot (round) t=0 corresponds to the end of the first phase. The number of time slots used during the second phase T_{used}={1, . . . , Tₘₐₓ} depends on the success of the decoding at the destination.

During a step E4, the destination selects the source sᵢ for which a retransmission is required. Such a source sᵢ is selected from the set of sources correctly decoded by at least one of the nodes but not by the destination at the end of the time slot t (round t), t∈{0, . . . , T_{used}−1}.

Thus, rather than leaving the choice of message to the nodes that have decoded without error a message transmitted by a source, the destination imposes the choice of message and therefore of the source for which a retransmission is required.

The source sᵢ selected by the destination is the source for which the signal-to-noise ratio associated with a global transmission channel is the highest.

Such a global transmission channel consists of all the composite transmission channels established between each of the nodes n_{i,j} that have decoded without error said message sent by said source s; and the destination. A composite transmission channel established between a node n_{i,j} and the destination is made up of at least two transmission channels established respectively between the node n_{i,j} considered and a first antenna A1 of the said destination and between the node n_{i,j} and a second antenna A2 of the destination.

By choosing the source for which the global transmission channel has a high signal-to-noise ratio, the destination increases its chances of decoding without error the message u; when it is retransmitted.

Knowing that the signal transmitted by a source sᵢ and received by the destination can be written as:

$${y}_{i} = {H}_{i} {v}_{i} {x}_{{S}_{i}} + {w}_{i}$$

where
γ∈ [symbol] ^{N}^{_{R}} is the vector of the N_{R} samples received by the N_{R} antennas of the destination, Hᵢ∈ [symbol] ^{N}^{_{R}}^{×|G}^{ᵢ}^{|} is the global transmission channel linking the |Gᵢ| nodes n_{i,j} with the N_{R} antennas of the destination with |Hᵢ|_{r,j} the transmission channel linking a node n_{i,j} to an antenna r at the destination, hereafter referred to as

$${h}_{r , {n}_{i , j}} ,$$

wᵢ is a vector of noise samples plus interference whose covariance is Rᵢ.

The destination then calculates the coefficients of a vector vᵢ of norm 1. Such a vector vᵢ is an eigenvector of

$${H}_{i}^{†} {R}_{i}^{- 1} {H}_{i}$$

where

$${H}_{i}^{†}$$

is the conjugate of the transpose of the matrix Hᵢ representing the global transmission channel and

$${R}_{i}^{- 1}$$

is the inverse matrix of the covariance matrix Rᵢ. The covariance matrix Rᵢ is the covariance matrix of noise plus interference, and corresponds to the statistical mean of

$${w}_{i} {w}_{i}^{†} ,$$

then

$${R}_{i} = \{ {w}_{i} {w}_{i}^{†} \} .$$

Such a vector vᵢ is associated with the maximum eigenvalue

$${λ}_{i} = {λ}_{max} ( {H}_{i}^{†} {R}_{i}^{- 1} {H}_{i} )$$

which maximises the signal-to-noise ratio of the global transmission channel Hᵢ.

In the case where Hᵢ is a vector of dimension N_{R} (a single node emits or |Gᵢ|=1) then

$${H}_{i}^{†} {R}_{i}^{- 1} {H}_{i}$$

is a scalar. We can then consider 1 as an eigenvector whose eigenvalue is

$${H}_{i}^{†} {R}_{i}^{- 1} {H}_{i} .$$

This case is rather uncommon, it is understood that in practice the coefficient to be applied to a single active node is chosen to be 1 without any further calculation.

In other words,

$${H}_{i}^{†} {R}_{i}^{- 1} {H}_{i} {v}_{i} = {λ}_{i} {v}_{i}$$

where λᵢ is the maximum eigenvalue. The signal-to-noise ratio of the global transmission channel is then maximised and SNR=|λᵢ|².

Thus, the destination knowing for all sources sⱼ j=1, . . . , M all the nodes ∀l∈{1, . . . , |Gᵢ|}n_{j,i}∈Gᵢ that have decoded this source and the transmission channels h_{r,n}_{_{j,i}}∀l∈{1, . . . , |Gⱼ|}∀r∈{1, . . . , N_{R}} or Hⱼ selects the source sᵢ which is assisted for a given retransmission by means of the following criterion:

$$i = {arg max}_{j} {λ}_{max} ( {H}_{j}^{†} {R}_{j}^{- 1} {H}_{j} )$$

In a step E5, once the source sᵢ for which a retransmission is required, the destination broadcasts a retransmission request RTM to all the nodes ∀j∈{1, . . . , |Gᵢ|}n_{i,j}∈Gᵢ which have decoded this source.

Such a retransmission request RTM includes an identifier of the source sᵢ and at least the vector vᵢ previously calculated.

In one example, the retransmission request RTM further includes a vector nᵢ allowing the nodes n_{i,j} concerned to identify whether they should transmit and the coefficient of the eigenvector vᵢ associated with it. The number of coefficients making up such a vector nᵢ corresponds to the number of nodes ∀j∈{1, . . . , |Gᵢ|}n_{i,j}∈Gᵢ that have decoded the source ŝᵢ without error. Thus, if five nodes have decoded the source without error, the vector nᵢ has five coefficients, each coefficient corresponding to one of the nodes.

On receipt of the retransmission request, each node n_{i,j} that decoded without error the message uᵢ transmitted by the source sᵢtransmits, in a step E6, the same redundancy of said message uᵢ transmitted by the source sᵢ.

The redundancy of the message transmitted by each node that decoded without error the message uᵢ transmitted by the source sᵢ is the same for each of these nodes. Such redundancy may be the RV0 redundancy transmitted during the first PH1 phase or any other redundancy in the message uᵢ. The transmission of redundancies can follow a defined order of reading start positions of the circular buffer for a message from a repeating source. For example, with reference to [FIG. 4] for 4 redundancy blocks/version, a systematic LDPC code and N_{1,s}=N₂∀s∈S the order can be Pos. 0, Pos. 2, Pos. 3, Pos. 1 and so on with RV0 and RV3 the redundancy versions associated with Pos. 0 and Pos. 3 which can be decoded independently of other blocks/versions (each second transmission is self-decodable).

Prior to the transmission of the redundancy of said message uᵢ transmitted by the source sᵢ, a node n_{i,j} applies the coefficient of the eigenvector v_{i,j}, or precoding coefficient, associated with it. Thus, the signal transmitted by a node n_{i,j} can be written as v_{i,j}xₛ_{ᵢ}. The signal transmitted by all the nodes ∀j∈{1, . . . , |Gᵢ|}n_{i,j}∈Gᵢ can be expressed as a vector vᵢxₛ_{ᵢ}

For example, three nodes ∀j∈{1, . . . , |Gᵢ|}n_{i,j}∈Gᵢ={1,4,5} that decoded the source ŝᵢ without error.

The cardinality of the set Gᵢ is 3, and the vector nᵢ is written as nᵢ=[1 4 5]^{T} with n_{i,1}=1, n_{i,2}=4, n_{i,3}=5.

Thus, a node n_{i,j} transmits a radio signal x_{ŝ}_{ᵢ} by applying the coefficient v_{i,j}∀j∈{1,2,3} associated with it:

$${x}_{{\hat{S}}_{i}} * {v}_{i , 1} \qquad node 1$$

$${x}_{{\hat{S}}_{i}} * {v}_{i , 2} \qquad node 4$$

$${x}_{{\hat{S}}_{i}} * {v}_{i , 3} \qquad node 5$$

FIG. 5 shows a destination belonging to an OMAMRC telecommunication system with M sources, optionally L relays and a destination, M≥2, L≥0 according to an embodiment of the development. Such a destination is able to implement the transmission method according to FIG. 3.

A destination may comprise at least one hardware processor 51, a storage unit 52 and at least one network interface 53 which are connected to each other via a bus 54. Naturally, the components of the destination can be connected by means of a connection other than a bus.

The processor 51 controls the operations of the destination. The storage unit 52 stores at least one program for implementing the method according to one embodiment of the development to be executed by the processor 51, and various data, such as parameters used for calculations performed by the processor 51, intermediate data for calculations performed by the processor 51, etc. The processor 51 may be formed by any known and appropriate hardware or software, or by a combination of hardware and software. For example, the processor 51 can be formed by a dedicated hardware such as a processing circuit, or by a programmable processing unit such as a Central Processing Unit which executes a program stored in a memory thereof.

The storage unit 52 may be formed by any appropriate means capable of storing the program or programs and data in a computer-readable manner. Examples of storage devices 52 include non-transitory computer-readable storage media such as semiconductor memory devices, and magnetic, optical or magneto-optical recording media loaded into a read/write device.

The network interface 53 provides a connection between the destination and the set of nodes ∈ [symbol] ∪ [symbol] .

1. A transmission method for an Orthogonal Multiple-Access Multiple-Relay Channel (OMAMRC) telecommunications system with N nodes and a destination (d) comprising at least two antennas in reception, the N nodes comprising M sources (s₁, . . . , s_{M}), possibly L relays (r₁, . . . , r_{L}) with M≥2, L≥0, the method comprising a first phase during which the destination receives first redundancies (RV0) of messages transmitted successively by the M sources, the message of a source having been coded before transmission by a coding of the incremental redundancy type comprising several redundancies and a second phase comprising the following implemented by the destination (d):
broadcasting a control message identifying one or more sources for which it has not decoded the transmitted message without error, referred to as undecoded sources,
receiving at least one identifier from at least one source sᵢ undecoded by the destination transmitted by a first set of nodes comprising at least one first node and one second node, taken from among the N nodes, having decoded without error the message from a source sᵢ,
determining, a first coefficient and a second coefficient from a matrix representing of a multiple-input multiple-output transmission channel established between the at least two nodes and at least two antennas in reception of the destination, called first and second precoding coefficients of the first node and second node respectively of the first set,
transmitting a retransmission request of the message from the source sᵢ to the at least two nodes, the retransmission request comprising the first precoding coefficient and the second precoding coefficient, and
receiving a second redundancy of the message from the source sᵢ transmitted by the first and second nodes, the second redundancy having been coded by the first node using the first precoding coefficient received and by the second node using the second precoding coefficient received.

2. The transmission method according to claim 1, wherein the first and second redundancy versions are different.

3. The transmission method according to claim 1, further comprising selecting the source sᵢ from a set of undecoded sources whose identifiers are received from the nodes, taken from the M sources and the L relays having decoded without error at least one message transmitted by the undecoded sources to the destination.

4. The transmission method according to claim 1, wherein the precoding coefficient is a coefficient of an eigenvector vᵢ of
$${H}_{i}^{†} {R}_{i}^{- 1} {H}_{i}$$
where
$${H}_{i}^{†}$$
is the conjugate of the transpose of a matrix Hᵢ representing a global transmission channel consisting of all the composite transmission channels established between each of the nodes having decoded without error the message transmitted by the source sᵢ and the destination, and
$${R}_{i}^{- 1}$$
is the inverse matrix of a covariance matrix Rᵢ of the noise plus interference associated with the global transmission channel.

5. The transmission method according to claim 4, wherein the source sᵢ selected is the source for which a signal-to-noise ratio associated with the global transmission channel is the highest.

6. The transmission method according to claim 4, wherein the request for retransmission of the at least one message transmitted by the source sᵢ comprises the eigenvector vᵢ.

7. The transmission method according to claim 6, wherein the request for retransmission of the at least one message transmitted by the source sᵢ further comprises a vector nᵢ representative of the cardinality of the set of nodes comprising at least one node having decoded without error the message transmitted by the source sᵢ, a coefficient of the vector nᵢ enabling at least one node of the set to identify the coefficient of the eigenvector vᵢ to be applied during the retransmission of the second redundancy.

8. The transmission method according to claim 1, wherein the messages intended to be transmitted by the M sources (s₁, . . . , s_{M}) are encoded by means of an incremental redundancy code and segmented into a plurality of redundancy blocks corresponding to different redundancy versions.

9. A system comprising M sources (s₁, . . . , s_{M}), L relays (r₁, . . . , r_{L}) and a destination (d), M≥2, L≥0, for implementing a transmission method according to ene of claim 1.

10. A processing circuit comprising a processor and a memory, the memory storing program code instructions of a computer program to execute the transmission method according to claim 1, when the computer program is executed by the processor.
